(19) United States
(12) Patent Application Publication
(10) Pub. No.: US 2018/0009622 A1
(43) Pub. Date: Jan. 11, 2018

(54) POST-PROCESSING APPARATUS AND IMAGE FORMING SYSTEM

(71) Applicant: FUJI XEROX CO., LTD., Tokyo (JP)

(72) Inventors: Kenji SUZUKI, Kanagawa (JP); Akira SAKUMA, Kanagawa (JP); Shinji MASAKI, Kanagawa (JP); Katsushi AMARUME, Kanagawa (JP); Kazunori KOIDO, Nagano (JP)

(73) Assignee: FUJI XEROX CO., LTD., Tokyo (JP)

(21) Appl. No.: 15/598,650

(22) Filed: May 18, 2017

(30) Foreign Application Priority Data
Jul. 5, 2016 (JP) 2016-133185

(51) Int. Cl. B65H 35/00; G03G 15/00

(52) U.S. Cl. CPC B65H 35/0006; G03G 15/6582; B65H 2801/27

(57) ABSTRACT

A post-processing apparatus includes a side edge part removing portion that removes a side edge part from a sheet; a side edge part housing portion that houses the side edge part of the sheet removed by the side edge part removing portion; and a side edge part action portion that acts on the removed side edge part and moves at least a portion of the side edge part.

### CROSS-REFERENCE TO RELATED APPLICATIONS

This application is based on and claims priority under 35 USC 119 from Japanese Patent Application No. 2016-133185 filed Jul. 5, 2016.

### BACKGROUND

### Technical Field

The present invention relates to a post-processing apparatus and an image forming system.

### SUMMARY

According to an aspect of the invention, there is provided a post-processing apparatus including a side edge part removing portion that removes a side edge part from a sheet; a side edge part housing portion that houses the side edge part of the sheet removed by the side edge part removing portion; and a side edge part action portion that acts on the removed side edge part and moves at least a portion of the side edge part.

### BRIEF DESCRIPTION OF THE DRAWINGS

An exemplary embodiment of the present invention will be described in detail based on the following figures, wherein:

FIG. 1 is a schematic sectional view showing an inside configuration of an image forming system;

FIG. 2 is a schematic sectional view of a post-processing apparatus according to an exemplary embodiment;

FIG. 3A illustrates a structure of a cutter unit included in a side edge part removing section, and FIG. 3B illustrates a side edge part of a sheet;

FIG. 4A is a schematic longitudinal section of a sheet-waste housing section, and FIG. 4B is a schematic cross section of the sheet-waste housing section;

FIG. 5A is a schematic cross section of the sheet-waste housing section showing a state in which the cutter unit has moved to the outermost side, and FIG. 5B is a schematic cross section of the sheet-waste housing section showing a state in which the cutter unit has moved to the innermost side;

FIG. 6A is a plan view of a raking member, and FIG. 6B is a front view of the raking member;

FIG. 7A is a schematic longitudinal section of the sheet-waste housing section in a jammed state with a side edge part, and FIG. 7B is a schematic cross section of the sheet-waste housing section in the jammed state with the side edge part; and

FIGS. 8A to 8C are perspective views for explaining a jam eliminating operation for a side edge part by the raking member.

### DETAILED DESCRIPTION

The present invention is described in detail below according to an exemplary embodiment and specific examples with reference to the drawings. However, the present invention is not limited to the embodiment and specific examples.

Also, in the description with reference to the drawings, it is to be noted that the drawings are schematic drawings and the ratio of respective dimensions etc. is different from the actual value. For easier understanding, illustration of members other than the members required for explanation is omitted as appropriate.

### (1) General Configuration and Operation of Image Forming System

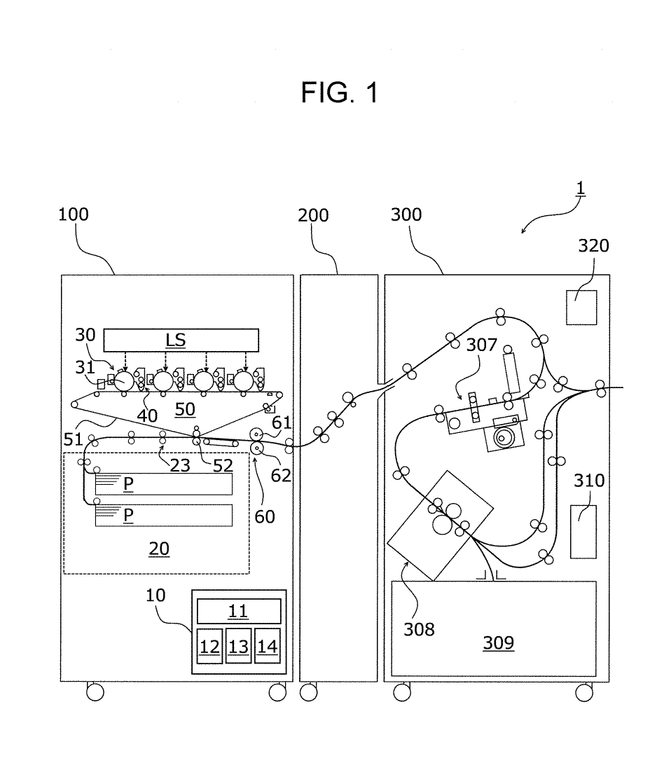

FIG. 1 is a schematic sectional view showing an inside configuration of an image forming system 1 to which this exemplary embodiment is applied. The image forming system 1 shown in FIG. 1, includes an image forming apparatus 100, such as a printer or a copier, that forms an image by an electrophotographic system, a transport apparatus 200 that guides a sheet P with an image recorded to a post-processing apparatus 300, and the post-processing apparatus 300 that provides post-processing on the sheet P with a toner image formed by the image forming apparatus 100.

A general configuration and an operation of the image forming system 1 are described below with reference to the drawings.

### (1.1) General Configuration and Operation of Image Forming Apparatus

The image forming apparatus 100 includes a control device 10, a sheet feed device 20, a photoconductor unit 30, developing devices 40, a transfer device 50, a fixing device 60, and an exposure device LS.

The control device 10 includes an image forming apparatus controller 11 that controls an operation of the image forming apparatus 100, a controller 12 that prepares image data in accordance with a print processing request, an exposure controller 13 that controls lighting of the exposure device LS, and a power supply device 14. The power supply device 14 supplies predetermined electric power to the photoconductor unit 30, the developing devices 40, the transfer device 50, the fixing device 60, and the exposure device LS.

The sheet feed device 20 in which sheets P as recording media are stacked is provided in a bottom portion of the image forming apparatus 100. The position in the width direction of the sheets P is determined by a regulation plate (not shown). The sheets P are drawn one by one from the top to the front, and then the drawn sheet P is transported to a nip part of a registration roller pair 23.

The photoconductor unit 30 includes photoconductor drums 31 that are arranged above the sheet feed device 20 in parallel to one another and are rotationally driven. The developing devices 40 form toner images of yellow (Y), magenta (M), cyan (C), and black (K) respectively on the photoconductor drums 31.

The toner images of the respective colors formed on the photoconductor drums 31 of the photoconductor unit 30 are sequentially electrostatically transferred (first transfer) on an intermediate transfer belt 51 of the transfer device 50, and thereby superimposed toner images in which the toners of the respective colors are superimposed are formed. The superimposed toner images on the intermediate transfer belt 51 are collectively transferred by a second transfer roller 52, on the sheet P sent out from the registration roller pair 23 and guided by a transport guide.

The sheet P with the toner images collectively transferred in the transfer device 50 is transported to the fixing device 60 in a state in which the toner images are not fixed. The toner images are fixed by an action of pressure and heat by a pair of a heat module 61 and a pressure module 62.

The sheet P with the fixed toner images formed is guided by a transport guide (not shown), and is transported through the transport apparatus 200 to the post-processing apparatus 300.

### (1.2) General Configuration and Operation of Post-processing Apparatus

The post-processing apparatus 300 includes a crease forming section 307 that forms creases on the sheet P received from the transport apparatus 200, a side edge part removing section (top and bottom trimmer) 308 that removes side edge parts CP of the sheet P, and a sheet-waste housing section 309 that houses the removed side edge parts CP of the sheet P as waste.

Further, the post-processing apparatus 300 includes a post-processing controller 310 that includes a central processing unit (CPU) and a read-only memory (ROM) and that controls respective functional sections of the post-processing apparatus 300. The post-processing apparatus 300 also includes a user interface (UI) 320 that receives an operation input from a user and relating to the post-processing.

In the image forming system 1, a finisher device may be connected subsequently to the post-processing apparatus 300 for sheets P output from the post-processing apparatus 300. The finisher device includes, for example, a compile tray that aligns and compiles the sheets P, an end binding mechanism (stapler) that binds end portions of the sheets P, and a center folding and binding processing mechanism that provides center folding and binding processing to make a booklet.

With such a system configuration, the image forming system 1 may continuously execute, for example, a series of works (print units) for creating a booklet.

### (2) Transport Apparatus

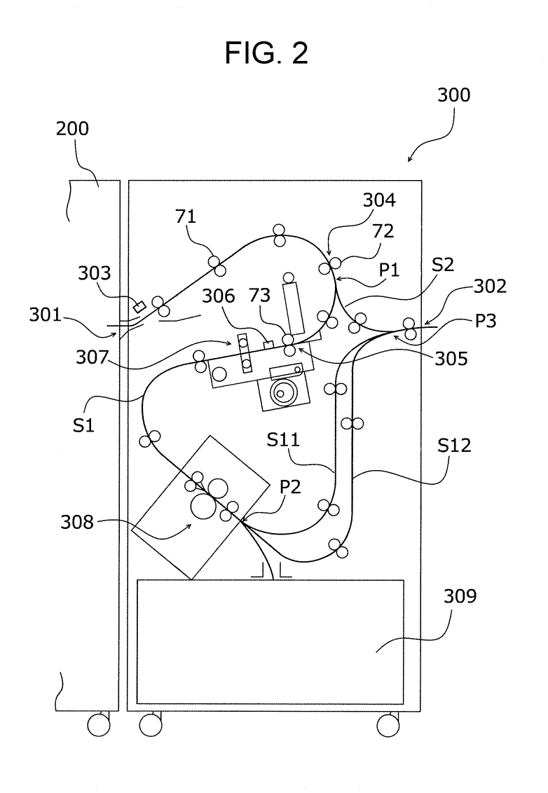

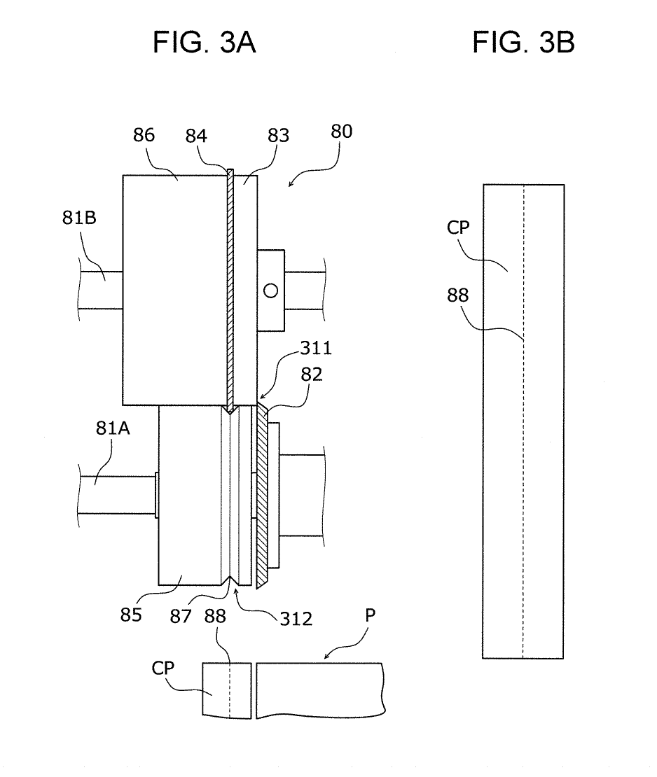

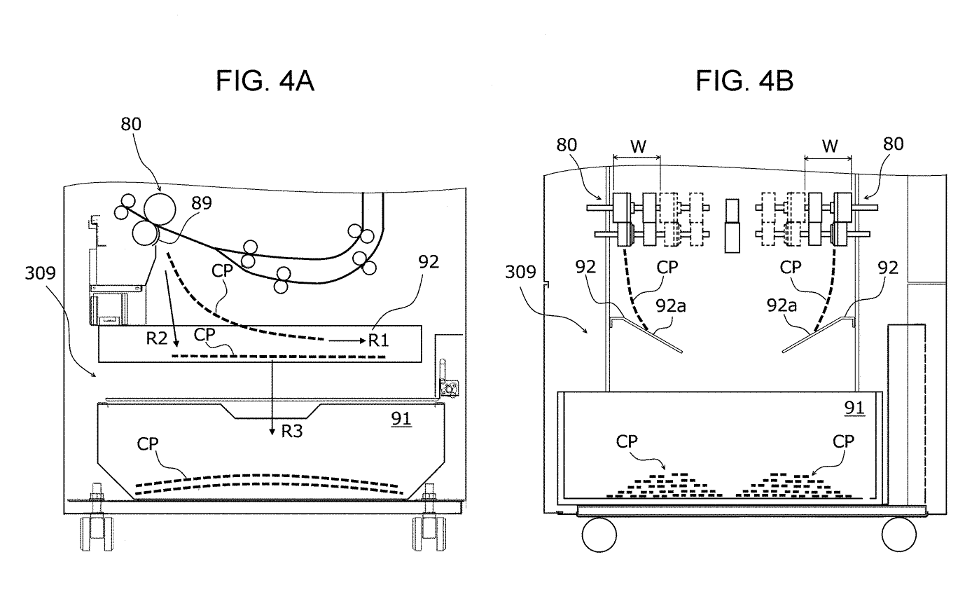

FIG. 2 is a schematic sectional view of the post-processing apparatus 300. FIG. 3A illustrates a structure of a cutter unit 80 included in the side edge part removing section 308, and FIG. 3B illustrates a side edge part CP of a sheet P. FIG. 4A is a schematic longitudinal section of the sheet-waste housing section 309, and FIG. 4B is a schematic cross section of the sheet-waste housing section 309.

A configuration and an operation of the post-processing apparatus 300 are described below with reference to the drawings.

### (2.1) General Configuration

As shown in FIG. 2, the post-processing apparatus 300 has a reception port 301 for receiving the sheet P transported from the image forming apparatus 100, and an output port 302 for outputting the sheet P.

Also, the post-processing apparatus 300 includes a skew detector 303 that detects skew of the received sheet P with respect to a transport direction of the sheet P, a first tilt corrector 304 having swing rollers 72 that correct skew, a second tilt corrector 305 that corrects skew by bringing the leading end of the sheet P into contact with skew correction rollers 73, a side detector 306 that detects the positions of both ends of the sheet P, the crease forming section 307 that forms creases on the sheet P, the side edge part removing section (top and bottom trimmer) 308 that removes side edge parts CP of the sheet P, and the sheet-waste housing section 309 that houses the removed side edge parts CP of the sheet P as sheet waste.

### (2.2) Sheet Transport Path

The post-processing apparatus 300 has a first sheet transport path S1 as a transport path of the sheet P. The first sheet transport path S1 extends from the reception port 301 as a start point to the output port 302.

Also, the first sheet transport path S1 is provided to pass through the skew detector 303, the first tilt corrector 304, the second tilt corrector 305, the side detector 306, the crease forming section 307, and the side edge part removing section (top and bottom trimmer) 308.

With the first sheet transport path S1, the sheet P received at the reception port 301 is transported to the skew detector 303, the first tilt corrector 304, the second tilt corrector 305, the side detector 306, the crease forming section 307, and the side edge part removing section 308.

The first sheet transport path S1 branches into a first branch path S11 and a second branch path S12 at a position located downstream of the side edge part removing section 308 (see P2 in FIG. 2). The first branch path S11 and the second branch path S12 join into one at a position located upstream of the output port 302 (see P3 in FIG. 2).

Further, the post-processing apparatus 300 has a second sheet transport path S2 branching from the first sheet transport path S1.

The second sheet transport path S2 branches from the first sheet transport path S1 at a position located downstream of the first tilt corrector 304 and upstream of the crease forming section 307 (see P1 in FIG. 2). The second sheet transport path S2 extends from a position at which the second sheet transport path S2 is connected with the first sheet transport path S1 as a start point to the output port 302.

A sheet P the creases of which are not formed by the crease forming section 307 and the side edge parts of which are not removed by the side edge part removing section 308 is transported through the second sheet transport path S2 to the output port 302.

The branch point (P1) at which the second sheet transport path S2 branches from the first sheet transport path S1, the branch point (P2) at which the first sheet transport path S1 branches into the first branch path S11 and the second branch path S12, and the joint point (see P3 in FIG. 2) at which the first branch path S11, the second branch path S12, and the second sheet transport path S2 join into one are provided with gates (not shown) for switching the transport path of the sheet P.

Also, plural transport rollers 71 are provided in the first sheet transport path S1 and the second sheet transport path S2. The transport rollers 71 transport the sheet P to the downstream side in the sheet transport direction.

### (2.3) Function and Operation of Post-processing Apparatus

The skew detector 303 includes two detecting members provided in a direction intersecting with (orthogonal to) the transport direction of the sheet P. Each detecting member includes a light emitting element and a light receiving element. The skew detector 303 calculates skew in the direction intersecting with (orthogonal to) the transport direction of the transported sheet P from a time difference in shielding of light when the sheet P passes through the two detecting members.

The first tilt corrector 304 includes the swing rollers 72. The swing rollers 72 include a driving roller that is rotationally driven by a motor, and a driven roller that is rotated by contacting the driving roller and receiving a driving force from the driving roller.

First ends of shafts of the swing rollers 72 are fixed, and second ends of the shafts are able to be tilted with respect to the direction intersecting with (orthogonal to) the transport direction of the sheet P. The tilt amount of the swing rollers 72 is set in accordance with the skew amount of the sheet P detected by the skew detector 303 immediately before the sheet P arrives.

If the swing rollers 72 pinch the sheet P in a tilted state, the state is restored from the tilted state to an original non-tilted state, and the sheet P is transported in a state in which the skew of the sheet P is corrected.

The second tilt corrector 305 corrects the skew of the sheet P corrected by the first tilt corrector 304, with higher accuracy. The second tilt corrector 305 includes the skew correction rollers 73 that correct the skew by bringing the sheet P into contact with the tilt correction rollers 73.

The skew correction rollers 73 are kept in a state in which rotation is stopped immediately before the sheet P contacts the skew correction rollers 73. The sheet P contacts the skew correction rollers 73 and forms a loop. The rotation of the skew correction rollers 73 is resumed at a timing at which the loop is generated, and the skew of the sheet P is corrected.

The side detector 306 detects ends of the sheet P in the direction orthogonal to the transport direction of the sheet P. For example, the positions of the ends of the sheet P are detected by line sensors. In this case, the positions of the ends in the direction orthogonal to the transport direction of the sheet P vary depending on the sheet P.

The crease forming section 307 includes advance members that advance from sides of the first sheet transport path S1 toward the first sheet transport path S1. By pressing the advance members to the sheet P, creases are formed on the sheet P. A device that provides folding processing disposed subsequently to the post-processing apparatus 300 folds the sheet P along the creases.

If the creases are not formed on the sheet P, the sheet P is transported to the side edge part removing section 308 without formation of the creases.

The side edge part removing section 308 is a device that executes trimming. The side edge part removing section 308 removes portions of side edge parts CP (side edge parts along the first sheet transport path S1) of the sheet P. The side edge part removing section 308 includes, for example, the cutter unit (rotary cutter unit) 80 (see FIG. 3A) having a shaft provided in the direction orthogonal to the transport direction of the sheet P and a disk-shaped blade fixed to the shaft.

The cutter unit 80 includes two cutter units 80 provided in the direction intersecting with (orthogonal to) the transport direction of the sheet P, and simultaneously removes side edge parts CP at both end portions of the sheet P.

The width of the sheet P varies depending on the booklet to be made. Hence the two cutter units 80 move along the shafts in accordance with the positions of the sides of the sheet P detected by the side detector 306 and the sizes of the side edge parts CP of the sheet P to be trimmed, and cut off the side edge parts CP of the sheet P.

The sheet-waste housing section 309 houses the side edge parts CP of the sheet P cut off in the side edge part removing section 308, as sheet waste.

If the sheet P is not trimmed, the sheet P is transported to the output port 302 in a state in which the side edge parts CP of the sheet P are not removed.

### (2.4) Side Edge Part Removal of Sheet

As shown in FIG. 3A, each cutter unit 80 includes a cutter portion 311 being an example of a side edge part removing portion, and a line applying portion 312 that gives stiffness to the sheet waste.

The cutter portion 311 includes a rotary cutter 82 being a disk-shaped blade, and a cylindrical pressing member 83 to which the rotary cutter 82 is pressed.

The line applying portion 312 includes a disk 84 and a groove 87 that receives an outer edge of the disk 84.

The rotary cutter 82, the pressing member 83, the disk 84, and the groove 87 are arranged around shafts 81A and 81B provided in parallel to the direction orthogonal to the transport direction of the sheet P.

The rotary cutter 82 and a cylindrical elastic body 85 made of rubber and having the groove 87 are provided around the shaft 81A with a predetermined gap interposed therebetween. The pressing member 83 to which the rotary cutter 82 is pressed, the disk 84 adjacent to the pressing member 83, and a cylindrical elastic body 86 made of rubber and being adjacent to the disk 84 are provided around the shaft 81B.

The disk 84 has a larger outer diameter than the outer shape of the pressing member 83. Hence the outer periphery of the disk 84 protrudes to the outside of the pressing member 83. It is to be noted that the outer diameter of the elastic body 86 is set to be equivalent to the outer diameter of the pressing member 83.

The outer periphery of the disk 84 is inserted into the groove 87 provided in the elastic body 85, the elastic body 85 contacts the elastic body 86, and thereby a driving force is transmitted.

With this configuration, when the shaft 81A receives the rotational driving, the elastic body 85 fixed to the shaft 81A is rotated, the driving force is transmitted to the elastic body 86 fixed to the shaft 81B, and the shaft 81B is rotated. Consequently, the side edge part CP is cut off from the sheet P pinched between the rotary cutter 82 and the pressing member 83.

It is to be noted that a pressure is applied to the rotary cutter 82 and the pressing member 83 by a spring (not shown) to mesh with one another.

As shown in FIG. 3B, a line 88 is formed in the transport direction of the sheet P along the side edge part CP of the sheet P. For example, in a case where the width of the side edge part CP of the sheet P is in a range from 6 to 25 mm, to allow the line 88 to be formed even if the width of the side edge part CP of the sheet P is 6 mm which is the narrowest, the line 88 is formed along the long and narrow side edge part CP at a 4-mm position from the rotary cutter 82.

The side edge part CP with the line 88 formed is not easily bent in a direction orthogonal to the line 88 as compared with a case without the line 88. The stiffness in the sheet transport direction of the side edge part CP is increased, the side edge part CP is not easily bent, and the rod shape is easily kept.

Consequently, as shown in FIG. 2, the side edge part CP of the sheet P trimmed by the cutter unit 80 advances in an oblique direction (in the lower right direction in FIG. 2) along the provided guide from the S2 portion, and is housed in the sheet-waste housing section 309.

The sheet P from which the side edge part CP is trimmed is transported along the provided guide from the S2 portion to the first branch path S11 or the second branch path S12.

### (2.5) Sheet-waste Housing Section

### (2.5.1) Configuration of Sheet-waste Housing Section

As shown in FIGS. 4A and 4B, the sheet-waste housing section 309 includes a sheet-waste housing box 91 and side edge part guides 92.

The sheet-waste housing box 91 houses the trimmed side edge parts CP. The sheet-waste housing box 91 is mounted so as to be pulled out to the front surface side (operator side) of the post-processing apparatus 300.

The side edge part guides 92 are plate-shaped members provided obliquely toward the direction of gravitational force. As shown in FIG. 4B, the side edge part guides 92 are arranged to define a truncated V shape.

The side edge part guides 92 are respectively provided below the left and right cutter units 80 in correspondence with the cutter units 80.

When the side edge parts CP with the lines 88 formed fall from the cutter units 80, front ends of the side edge parts CP are guided by inclined surfaces 92a of the side edge part guides 92, and move in a sliding manner in the horizontal direction (arrow R1 in FIG. 4A) on the inclined surfaces 92a.

Then, rear ends of the side edge parts CP having rod shapes because the lines 88 are formed fall on the inclined surfaces 92a of the side edge part guides 92 (arrow R2 in FIG. 4A). Consequently, the side edge parts CP fall substantially horizontally in the sheet-waste housing box 91 (arrow R3 in FIG. 4A), and are housed in the sheet-waste housing box 91 without forming a hill in the moving direction of the side edge parts CP in the sheet-waste housing box 91. Accordingly, housing efficiency of the sheet-waste housing box 91 may be increased.

### (2.5.2) Operation of Cutter Units

As shown in FIG. 4B, the cutter units 80 each move in a direction intersecting with the transport direction of the sheet P in accordance with the size (width) of the sheet P to be trimmed. The cutter unit 80 has a movement range W between a position Q1 at the outermost side and a position Q2 at the innermost side. The position Q1 at the outermost side is a reference position (hereinafter, referred to as home position). The cutter unit 80 moves from the home position Q1 to a predetermined position in accordance with the size of the sheet P and trims the side edge part CP of the transported sheet P.

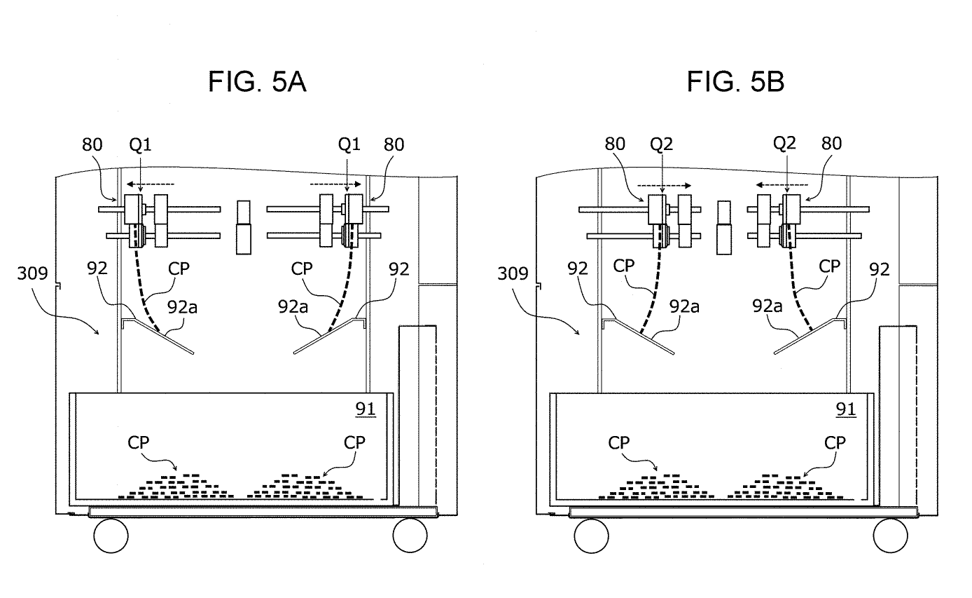

FIG. 5A is a schematic cross section of the sheet-waste housing section 309 showing a state in which the cutter unit 80 has moved to the outermost side. FIG. 5B is a schematic cross section of the sheet-waste housing section 309 showing a state in which the cutter unit 80 has moved to the innermost side.

As shown in FIGS. 5A and 5B, when a predetermined post-processing job is ended, simultaneously with the end of trimming for the final sheet, the cutter unit 80 moves to the home position Q1, and then reciprocates within the movement range W. To be specific, the cutter unit 80 moves to the home position Q1 (see FIG. 5A), then moves to the position Q2 at the innermost side (see FIG. 5B), and moves to the home position Q1 again.

Consequently, even if the rear end of the trimmed side edge part CP remains on a contact prevention covering 89 (see FIG. 4A) covering the elastic body 85 of the cutter unit 80 and the side edge part CP does not smoothly fall to the side edge part guide 92, since the contact prevention covering 89 reciprocates within the movement range W of the cutter unit 80, the side edge part CP is thrown off to left and right, hence the rear end gets an opportunity of separating from the contact prevention covering 89, and clogging (hereinafter, referred of as jam) with the side edge part CP may be reduced.

### (2.5.3) Jam Elimination by Raking Member

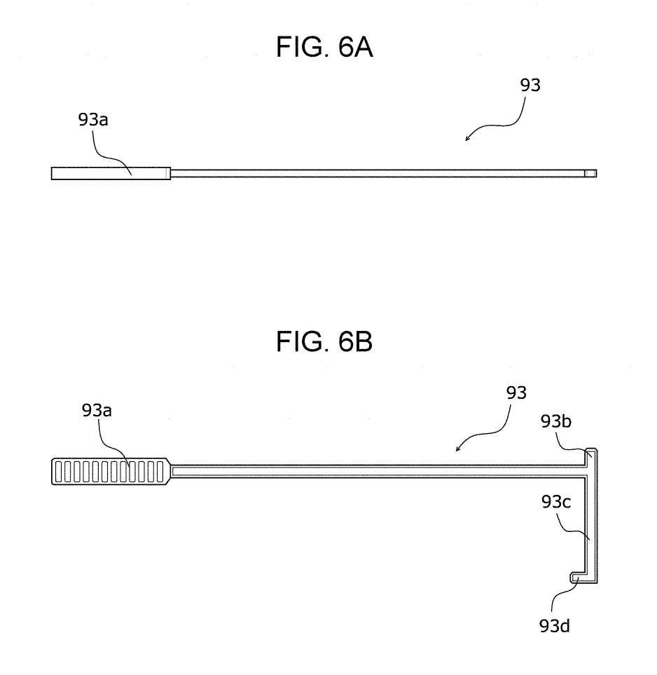

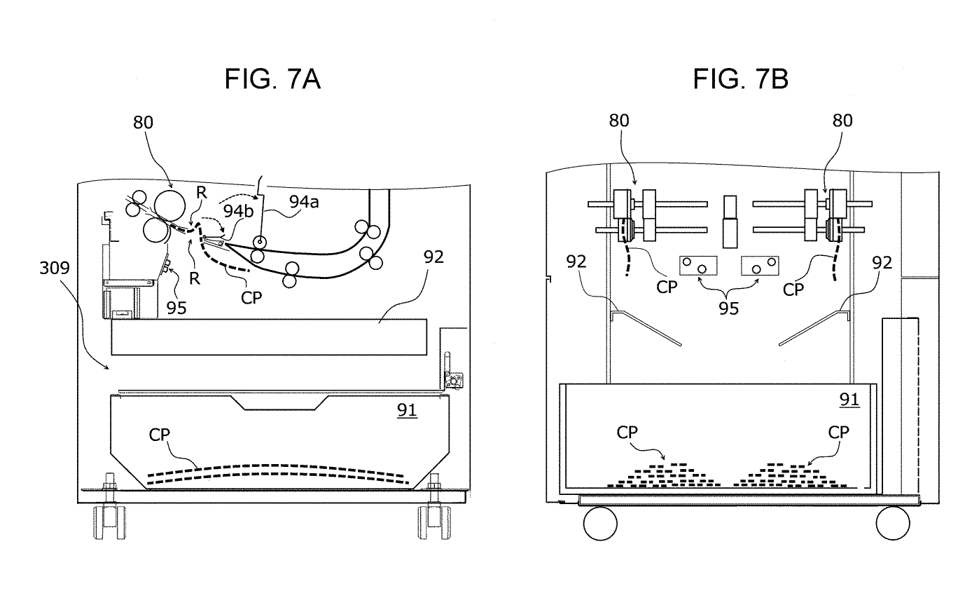

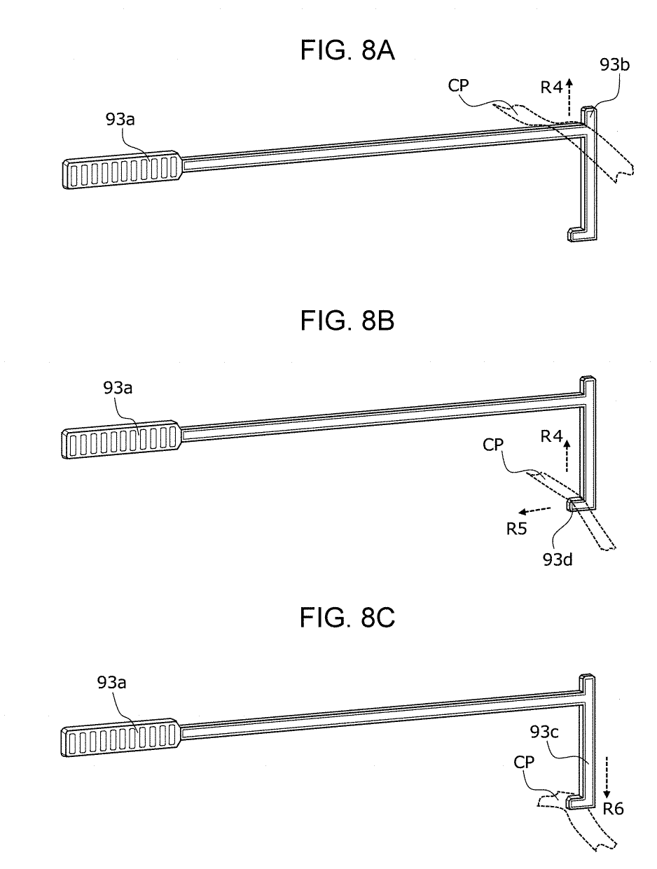

FIG. 6A is a plan view of a raking member 93, and FIG. 6B is a front view of the raking member 93. FIG. 7A is a schematic longitudinal section of the sheet-waste housing section 309 in a jammed state with a side edge part CP, and FIG. 7B is a schematic cross section of the sheet-waste housing section 309 in the jammed state with the side edge part CP. FIGS. 8A to 8C are schematic views for explaining a jam eliminating operation for a side edge part CP by the raking member 93.

As shown in FIGS. 6A and 6B, the raking member 93 is a rod-shaped or substantially rod-shaped member including a grip 93a that is gripped by the operator, a first protrusion 93b that hooks a portion of a remaining side edge part CP, a hook 93c formed to extend to a side opposite to the first protrusion 93b, and a second protrusion 93d formed at a tip end portion of the hook 93c.

As shown in FIG. 6A, the raking member 93 is integrally formed of soft synthetic resin as a thin plate-shaped member having a thickness in a range from 2 to 5 mm from the grip 93a to the first protrusion 93b. The soft synthetic resin may be, for example, polypropylene (PP), polyacetal (POM), or polyethylene (PE).

With this configuration, if a jam with a trimmed side edge part CP is generated in the sheet-waste housing section 309, the raking member 93 is operated to make an access to a very small space, and hence may eliminate the jam.

As shown in FIGS. 7A and 7B, upper and lower guides 94a and 94b are provided downstream of the cutter units 80 and upstream of the first branch path S11 and the second branch path S12. The upper and lower guides 94a and 94b may be opened and closed. The sheet P from which the side edge parts CP are trimmed passes through a transport path formed of the upper and lower guides 94a and 94b, and is transported to the first branch path S11.

On the other hand, while the trimmed side edge parts CP are guided to the lower side of the cutter units 80 and are guided to the side edge part guides 92, as shown in FIG. 7A, a jam may be generated at the downstream side of the cutter units 80.

The post-processing apparatus 300 according to this exemplary embodiment includes the raking member 93 that is detachably attached to the front surface side (pull-out side) of the sheet-waste housing box 91.

Further, as shown in FIGS. 7A and 7B, an LED unit 95 being an example of an illuminating unit is arranged below the cutter units 80.

If a jam with a side edge part CP is generated at the downstream side of the cutter units 80, the operator may perform the jam eliminating operation by using the raking member 93 in the sheet-waste housing section 309 while visual recognizability is increased by illumination with the LED unit 95.

To be specific, in a state in which the upper and lower guides 94a and 94b are rotated (see arrows in FIG. 7A) and a jam eliminating operation region R is opened, the side edge part CP may be drawn to the outside of the sheet-waste housing section 309 and removed by using the first protrusion 93b and the second protrusion 93d of the raking member 93, and the side edge part CP may be dropped in the sheet-waste housing box 91 by using the hook 93c.

FIGS. 8A to 8C show examples of the jam eliminating operation for a side edge part CP by using the raking member 93. As shown in FIG. 8A, a side edge part CP remaining at the deep side of the sheet-waste housing section 309 may be removed by lifting the side edge part CP to the upper side (see arrow R4 in FIG. 8A) from the jam eliminating operation region R by using the first protrusion 93b of the raking member 93.

Also, as shown in FIG. 8B, the side edge part CP remaining at the front surface side of the sheet-waste housing section 309 may be removed by raking the side edge part CP to the front side (operator side: see arrow R5 in FIG. 8B) from the jam eliminating region R while being lifted to the upper side (see arrow R4 in FIG. 8B) by using the second protrusion 93d of the raking member 93.

Further, as shown in FIG. 8C, a side edge part CP remaining at the front side and the deep side of the sheet-waste housing section 309 may be removed by dropping the side edge part CP from the jam eliminating operation region R into the sheet-waste housing box 91, which is located at the lower side (see arrow R6 in FIG. 8C), by using the hook 93c of the raking member 93.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A post-processing apparatus comprising:
a side edge part removing portion that removes a side edge part from a sheet;
a side edge part housing portion that houses the side edge part of the sheet removed by the side edge part removing portion; and
a side edge part action portion that acts on the removed side edge part and moves at least a portion of the side edge part.

2. The post-processing apparatus according to claim 1,
wherein the side edge part action portion is the side edge part removing portion that reciprocates in a direction intersecting with a transport direction of the sheet, and after the side edge part of the sheet is removed, the side edge part removing portion moves between an outermost side and an innermost side of a movement range in a reciprocation direction and drops the removed side edge part.

3. The post-processing apparatus according to claim 2,
wherein the side edge part removing portion moves to the outermost side of the movement range in the reciprocation direction, then moves to the innermost side of the movement range, moves to the outermost side again, and drops the removed side edge part.

4. The post-processing apparatus according to claim 1,
wherein the side edge part action portion is a raking member that acts on an end of the side edge part removed by the side edge part removing portion and remaining at an upper side of the side edge part housing portion and rakes the side edge part.

5. The post-processing apparatus according to claim 4,
wherein the raking member is a substantially rod-shaped member including a grip that is formed at a first end of the raking member and gripped by an operator, a first protrusion that is formed at a second end of the raking member and hooks a portion of the remaining side edge part, a hook that is formed to extend to a side opposite to the first protrusion and drops a portion of the remaining side edge part, and a second protrusion that is formed at a tip end portion of the hook and hooks a portion of the remaining side edge part, the substantially rod-shaped member being housed in the side edge part housing portion in an attachable and detachable manner.

6. The post-processing apparatus according to claim 4,
wherein the raking member is made of soft synthetic resin.

7. The post-processing apparatus according to claim 4, further comprising:
an illuminating unit that emits illumination light, the illuminating unit illuminating the remaining side edge part.

8. An image forming system comprising:
an image forming apparatus that forms an image on a sheet; and
the post-processing apparatus according to claim 1.
